(19) United States
(12) Patent Application Publication
(10) Pub. No.: US 2003/0004911 A1
(43) Pub. Date: Jan. 2, 2003

(54) Device and method to enhance verification of biometric features

(76) Inventor: Judy Shuk-Ching Wong, Hong Kong (HK)

Correspondence Address: Ronald Drumheller, 94 Teakettle Spout Rd., Mahopac, NY, 10541, US

(21) Appl. No.: 10/187,554

(22) Filed: Jul. 2, 2002

(30) Foreign Application Priority Data
Jul. 2, 2001 (CN) 01 1 22128.3

(51) Int. Cl. G06N 5/00

(52) U.S. Cl. 706/45

(57) ABSTRACT

The invention provides a method and a device which can be applied in an automated biometric identification system to effectively differentiate biometric features from live or dead source and detect falsified biometric features. By the deployment of a recognition software, the biometric data of the subject submitted for automated verification are interpreted against some pre-set biometric characteristics, which will detect falsified or dead biometric features. Besides, the device is in the form of software which will reduce the cost of the automated biometric identification system as compared to using hardware detection device.

### BACKGROUND OF THE INVENTION

1. Field of the Invention

The invention relates to the technical field of identification or verification of biometric features, and more specifically to a device and a method for improving the reliability and accuracy of identification or verification through a person's biometric features.

2. Related Art

A trend is emerging where more and more organizations, such as customs inspection office, finance company and security establishment, resort to establishing a person's identity through his biometric features. This is achieved by recording his biometric data in a chip card such as an identification card or a credit card. And when this person is submitted to be identified or verified, his biometric features are firstly physically captured, and then compared with the pre-recorded biometric data to detect if they are identical. Some biometric features of a person, such as fingerprint, are unique, so this person will be positively identified or verified. As a result, the risk of the fraud is reduced. There are different types of biometric features adopted in identification system, for example, fingerprint, hand geometry, voice and iris etc. However, the problem in the known identification or verification process is that the risk of fraud still exists because the biometric data are electrically stored and can be forged.

The most common and reliable biometric feature identification method is the fingerprint identification method. A wide range of Automated Finger Identification Systems(AFIS) are available in the market to satisfy the requirements of different customers. However, in the more sophisticated forgery or impersonation cases, the imposter would use the replica of the genuine card holder's fingerprint or might even resort to user a severed finger to go through the automated identification or verification process.

To solve the above problem, specialized hardware devices have been developed to detect the above forgeries. One way to detect whether the finger is live or dead is to measure the temperature or pulse of the person under verification by using a specialized hardware device. However, the cost of the AFIS increases because of the additional hardware, and the verification result may not always be reliable due to many factors, such as the environment condition in which the identification or verification process is carried out.

### SUMMARY OF THE INVENTION

The object of the invention is to provide a device which can be implemented in the form of software and incorporated into an automated biometric identification system to determine whether the biometric features are from a live source and to detect falsified biometric features.

In order to implement the above object, the invention provides a device which is used in an automated biometric identification system to enhance the verification of biometric features, the system comprises an input means for accepting biometric data of a person, including a first set of biometric data and a second set of biometric data;

a detection means for interpreting the first set of biometric data against a set of pre-stored biometric data to determine whether the first set of biometric data is falsified or not,

the device being characterized in that:

it determines whether the first set of biometric data is genuine and derived from a live source based on the second set of biometric data.

The device may also comprise alarm means for sending out an alert message, when falsified or dead biometric features are detected. In order to implement the above object, the invention provides a method which is used in an automated biometric identification system to enhance the verification of biometric features, the system comprises an input means for accepting biometric data of a person, including a first set of biometric data and a second set of biometric data; a detection means for interpreting the first set of biometric data against a set of pre-stored biometric data to determine whether the first set of biometric data is falsified or not, the method is characterized in that: it comprises the steps: extracting the second set of biometric data from the input means; determining whether the first set of biometric data is are genuine and derived from a live source based on the second set of biometric data, and sending out an alert message, when falsified or dead biometric features are detected.

The device according to the invention has the advantage of intelligently detecting the fraud which cannot otherwise be recognized by an ordinary automated biometric identification system. By adopting the invention, the verification result will be more reliable and the resistance to fraud of the automated biometric identification system will also be improved. Moreover, the device may be incorporated into an automated biometric identification system in the form of a software. This has the benefit of lowering the cost as compared with the use of specialized detection hardware as well as making implementation easier.

### BRIEF DESCRIPTION OF THE DRAWINGS

FIG. 1 shows the block diagram of the device for enhancing verification of biometric features according to the invention which may be incorporated into an automated biometric identification system.

FIG. 2 shows the schematic diagram of the first embodiment of the invention.

FIG. 3 shows the flow chart of the method for enhancing verification of biometric features according to the invention.

### DETAILED DESCRIPTION OF THE INVENTION

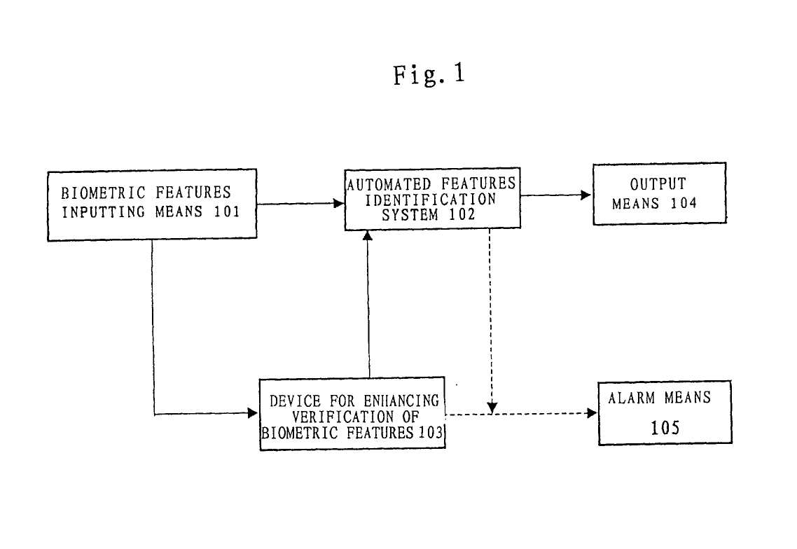

The device for enhancing verification of biometric features 103 according to the invention may be installed in an existing automated biometric identification system 102, in the form of a software function module, without increasing any hardware overhead. As shown in FIG. 1, the biometric data inputting means 101 may be any apparatus in the form of software and/or hardware for capturing biometric data of a person to be identified or verified, such as an optical scanner.The automated biometric identification system 102 receives a first set of biometric data captured by the inputting means 101, matches the captured data with the pre-stored biometric data of the registered card holder based on certain matching algorithm, and outputs the identification result. In parallel, the device for enhancing verification of biometric features 103 according to the invention receives the biometric data from the inputting means 101, and extracts a second set of biometric data from the data received, the second set of biometric data being different from the first set of biometric data and determines whether the first set of biometric features is genuine and derived from a live source. The process of the device for enhancing verification of biometric features 103 will be described later. The output means 104 sends out the identification results of the automated biometric identification system 102 and the device 103. Persons skilled in this field understand that the results may be output in the form of voice, image, literal character or their combination. The device for enhancing verification of biometric features 103 may specially comprise an alarm means 105, which sends out alert message when the device detects falsified or dead biometric features of the person submitted for verification. Alternatively, the alarm means 105 can be combined into the output means 104, or the output means 104 may implement the function of the alarm means 105.

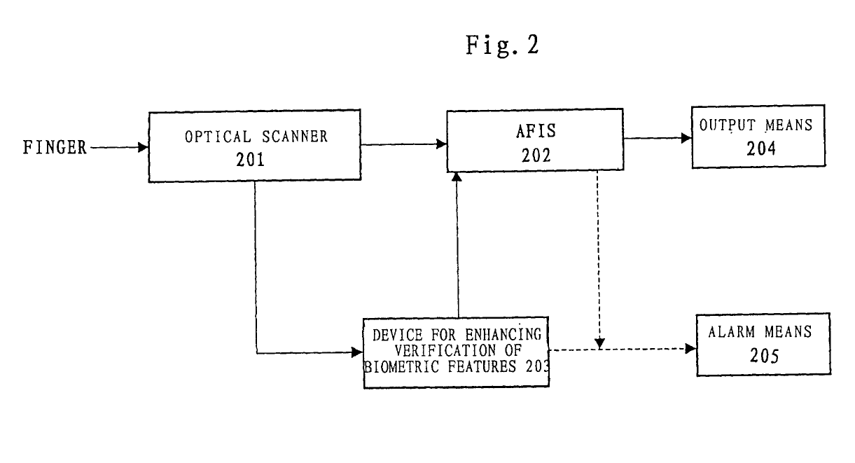

FIG. 2 shows an example embodying the concept of FIG. 1. In this example, the concept of the invention is illustrated by reference to an Automated Fingerprint Identification System (AFIS).

In the ordinary AFIS, the image or data of the fingerprint of the person undergoing identification or verification process are input through a hardware (e.g., an optical scanner). Then the input image or data of the fingerprint will be compared with the pre-stored biometric data to make the identification. However, as explained in the background section, the more sophisticated forger can circumvent the identification or verification process by putting on a latex replica of the fingerprint or a severed finger of the genuine card holder. That is to say, the recognition result of the ordinary AFIS is not reliable.

In the embodiment shown in FIG. 2, the reliability of the verification result of biometric data by the AFIS will be improved by adding the device for enhancing verification of biometric features according to the invention to the AFIS.

As shown in FIG. 2, the optical scanner 201 captures the biometric data of the fingerprint of the person undergoing the identification or verification process. The AFIS 202 extracts the fingerprint data from the biometric data of the finger input through the optical scanner 201, the fingerprint data are treated as the first set of biometric data. And then the AFIS 202 matches the first set of biometric data with the pre-stored biometric data of the genuine card holder according to a certain designed matching algorithm, and outputs the identification or verification result.

The device for enhancing verification of biometric features 203 according to the invention also receives the biometric data of the finger inputted by the optical scanner 201, and extracts a second set of the biometric data from the data received, the second set of the biometric data being, for example, the sweat gland/pore distribution data. And then the device 203 determines whether the second set of the biometric data is derived from a live source by checking, for example, if there is the sweat gland/pore distribution data, or the sweat gland/pore distribution data extracted has the characteristics of a live finger. And an alarm message will be sent out from the alarm means 205 if there is no sweat gland/pore distribution data or the sweat gland/pore distribution data are abnormal. It is understandable for the persons skilled in this field that the alarm means 205 may be any mechanism which can send out different alarm message.

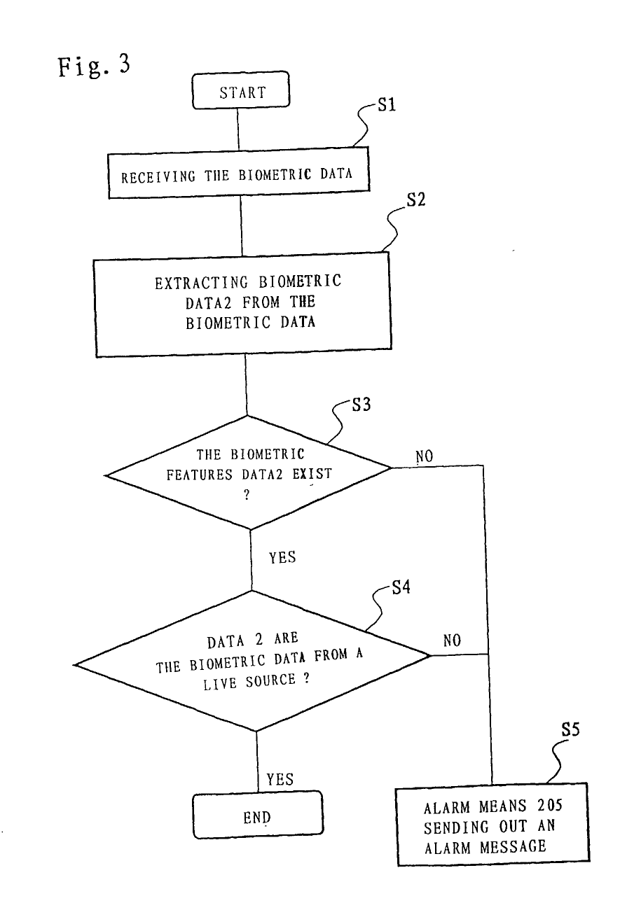

FIG. 3 shows the flow chart of the method for enhancing verification of biometric features according to the invention.

At step S1, the device for enhancing verification of biometric features 203 according to the invention receives the biometric data DATA.

Then, at step S2, the device 203 extracts biometric data DATA2 from the DATA, which are different from the biometric data DATA1 processed by the AFIS 202.

At step S3, the device detects if there are DATA2;and if yes, proceed to step S4, if no, proceed to step S5. At step S4, the device 203 determines if DATA 2 are biometric data derived from a live source. And if yes, the process ends, if no, proceed to step S5.

At step S5, an alarm message is sent out by the alarm means 205.

The device for enhancing verification of biometric features 203 according to the invention and its process have been described by reference to FIGS. 2 and 3. The method according to the invention can be applied to automated biometric identification systems and the device for enhancing verification of biometric features 203 according to the invention can be incorporated into automated identification system as a hardware independent and “open standard” software, in particular, the AFIS.

Furthermore, the sweat gland/pore distribution data are used as the second set of the biometric data in the embodiments. However, it is not limited to the sweat gland/pore distribution data so far as the second set of the biometric data has the characteristics of a live source.

The invention has been described in details by reference to the embodiments and the drawings, which, however, are not used to limit the invention. And the invention can be modified and improved without departing from the spirit and the scope of the claims.

What is claimed:

1. A device which is used in an automated biometric features identification system to enhance verification of biometric features, the system comprises
an input means for accepting biometric data of a person, including a first set of biometric data and a second set of biometric data;
a detection means for interpreting the first set of biometric data against set of a pre-stored biometric data to determine whether the first set of biometric data is falsified or not,
the device being characterized in that:
it determines whether the first set of biometric data is genuine and derived from a live source based on the second set of biometric data.

2. The device according to claim 1, wherein the first set of biometric data is fingerprint data, and the second set of biometric data is sweat gland/pore data.

3. The device according to claim 1, wherein the device also comprises an alarm means for sending out an alert message when the device detects falsified or dead biometric features of the person submitted for verification.

4. A method which is used in an automated biometric features identification system to enhance the verification of biometric features, the system comprises an input means for accepting biometric data of a person, including a first set of biometric data and a second set of biometric data; a detection means for interpreting the first set of biometric data against a set of pre-stored biometric data to determine whether the first set of biometric data is falsified or not, the method is characterized in that:
it comprises the steps of
extracting the second set of biometric data from the input means;
determining whether the first set of biometric data is genuine and derived from a live source, based on the second set of biometric data; and
sending out an alert message, when falsified or dead biometric features are detected.

5. The device according to claim 1, wherein the first set of biometric data is fingerprint data, and the second set of biometric data is sweat gland/pore data.
